(19) United States
(12) Patent Application Publication
(10) Pub. No.: US 2011/0072045 A1
(43) Pub. Date: Mar. 24, 2011

(54) Creating Vertical Search Engines for Individual Search Queries

(75) Inventor: Theodore Clark Drake, San Carlos, CA (US)

(73) Assignee: YAHOO! INC., Sunnyvale, CA (US)

(21) Appl. No.: 12/565,077

(22) Filed: Sep. 23, 2009

(51) Int. Cl. G06F 17/30

(52) U.S. Cl. 707/770; 707/E17.014

(57) ABSTRACT

In one embodiment, access a first search query received by a search engine; dynamically construct a list of network resources for the first search query, the list of network resources comprising one or more network resources that are relevant to the first search query, the list of network resources being determined based on analysis of a plurality of user-provided network resources; conduct a first search through the list of network resources using the first search query; and generate a first search result for the first search query based on a result of the first search.

### TECHNICAL FIELD

The present disclosure generally relates to vertical search engines and more specifically relates to constructing subject-matter-specific lists of network resources suitable for vertical searches.

### BACKGROUND

The Internet provides a vast amount of information. The individual pieces of information are often referred to as “network resources” or “network contents” and may have various formats, such as, for example and without limitation, texts, audios, videos, images, web pages, documents, executables, etc. The network resources or contents are stored at many different sites, such as on computers and servers, in databases, etc., around the world. These different sites are communicatively linked to the Internet through various network infrastructures. Any person may access the publicly available network resources or contents via a suitable network device (e.g., a computer) connected to the Internet.

However, due to the sheer amount of information available on the Internet, it is impractical as well as impossible for a person (e.g., a network user) to manually search throughout the Internet for specific pieces of information. Instead, most people rely on different types of computer-implemented tools to help them locate the desired network resources or contents. One of the most commonly and widely used computer-implemented tools is a search engine, such as the search engines provided by Yahoo!® Inc. (http://search.yahoo.com) or Google™ Inc. (http://www.google.com). To search for information relating to a specific subject matter on the Internet, a network user typically provides a short phrase describing the subject matter, often referred to as a “search query”, to a search engine. The search engine conducts a search based on the query phrase using various search algorithms and generates a search result that identifies network resources or contents that are most likely to be related to the search query. The network resources or contents are presented to the network user, often in the form of a list of links, each link being associated with a different document (e.g., a web page) that contains some of the identified network resources or contents. In particular embodiments, each link is in the form of a Uniform Resource Locator (URL) that specifies where the corresponding document is located and the mechanism for retrieving it. The network user is then able to click on the URL links to view the specific network resources or contents contained in the corresponding document as he wishes.

Sophisticated search engines implement many other functionalities in addition to merely identifying the network resources or contents as a part of the search process. For example, a search engine usually ranks the identified network resources or contents according to their relative degrees of relevance with respect to the search query, such that the network resources or contents that are relatively more relevant to the search query are ranked higher and consequently are presented to the network user before the network resources or contents that are relatively less relevant to the search query. The search engine may also provide a short summary of each of the identified network resources or contents.

There are continuous efforts to improve the qualities of the search results generated by the search engines. Accuracy, completeness, presentation order, and speed are but a few of the performance aspects of the search engines for improvement.

### SUMMARY

The present disclosure generally relates to vertical search engines and more specifically relates to constructing subject-matter-specific lists of network resources suitable for vertical searches.

Particular embodiments access a first search query received by a search engine; dynamically construct a list of network resources for the first search query, the list of network resources comprising one or more network resources that are relevant to the first search query, the list of network resources being determined based on analysis of a plurality of user-provided network resources; conduct a first search through the list of network resources using the first search query; and generate a first search result for the first search query based on a result of the first search.

These and other features, aspects, and advantages of the disclosure are described in more detail below in the detailed description and in conjunction with the following figures.

### BRIEF DESCRIPTION OF THE DRAWINGS

FIG. 1 (PRIOR ART) illustrates an example implementation of a vertical search engine.

FIG. 2 illustrates an example search engine that incorporates dynamic lists of network resources constructed for individual search queries.

FIG. 3 illustrates an example method for incorporating dynamic lists of network resources constructed for individual search queries to a search process.

FIG. 4 illustrates an example network environment.

FIG. 5 illustrates an example computer system.

### DETAILED DESCRIPTION

The present disclosure is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

A search engine is a computer-implemented tool designed to search for information relevant to specific subject matters or topics on a network, such as the Internet or the World Wide Web. To conduct a search, a network user may issue a search query to the search engine. The search query generally contains one or more words that describe a subject matter. In response, the search engine may identify one or more network resources that are likely to be related to the search query, which may collectively be referred to as a “search result” identified for the search query. The network resources are usually ranked and presented to the network user according to their relative degrees of relevance to the search query.

Search engines such as the ones provided by Yahoo!® Inc. or Google™ Inc. may be considered as “broad-based search engines” because, for each search query issued to such a search engine, the search engine identifies the network resources relevant to the search query from all or almost all of the network resources available on the Internet using a Web crawler or an indexer. As a result, the number of network resources identified for a search query may be quite large due to the great number of network resources publicly available on the Internet. For example, for search query “vegetarian recipes”, a broad-based search engine may identify approximately 71,600,000 web pages as its corresponding search result. It is very unlikely that all of these web pages contain information specifically useful to the network user requesting the search. On the contrary, it is more likely that only a few web pages among the millions of the web pages identified by the broad-based search engine that may contain the specific information that the network user is searching for. And yet, the network user may need to exam the contents of many web pages in order to locate the desired specific pieces of information.

Recently, a relatively new tier in the Internet search industry has emerged that provides “specialized” searches. Search engines that perform specialized searches may be considered as “specialized search engines”, which focus on searching through specific slices of network resources or contents. One type of specialized searches is vertical searches, and search engines that perform vertical searches may be considered as “vertical search engines”. A vertical search engine typically locates information concerning a specific subject matter or topic. In this context, the term “vertical” may be considered as referring to a particular subject matter or topic in which the vertical search engine specializes. The subject matters or topics in which the individual vertical search engines specialize may vary greatly. For example, ChemSpider (http://www.chemspider.com) is a vertical search engine that specializes in chemical structures or structure-based chemistry information; TechCrunch (http://search.techcrunch.com) is a vertical search engine that specializes in technology; Trulia® (http://www.trulia.com) is a vertical search engine that specializes in real estate; Truevert (http://www.truevert.com) is a vertical search engine that specializes in ecology and green living; and V3GGIE (http://v3ggie.com) is a vertical search engine that specializes in vegetarian food.

A vertical search engine typically relies on one or more highly refined databases that contain only the information concerning the corresponding subject matter or topic in which the vertical search engine specializes. For example, a database associated with a vertical search engine may contain a list of network resources (e.g., websites or web pages) known to be related to the particular subject matter in which the vertical search engine specializes. Such a list of network resources may be referred to as a “curated” list associated with the vertical search engine.

Upon receiving a search query, the vertical search engine only searches through the specialized network resources stored in the refined databases (i.e., the associated curated list of network resources), as oppose to searching through all of the public network resources on the Internet as in the case of a broad-based search engine, to identify the search result for the search query. As a result, there may be fewer but more focused and higher quality pieces of information contained in the search result identified for the search query. For example, for search query “vegetarian recipes”, V3GGIE, which specializes in vegetarian food, identifies approximately 3,235,041 web pages as its corresponding search result, much less than the number of web pages identified by a broad-based search engine. Such focused search results may be more valuable to network users interested in particular areas of information, subject matters, or topics.

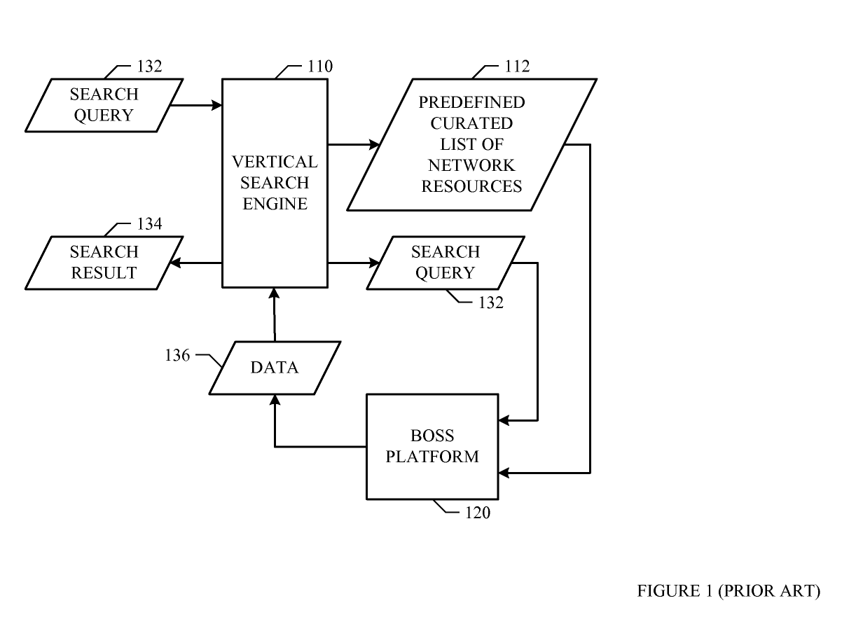

A vertical search engine may be implemented using various technologies. For example, Yahoo!® Inc. provides an open search web services platform called BOSS (http://developer.yahoo.com/search/boss), which stands for “Build your Own Search Service”, that includes a set of application programming interfaces (APIs) that enables individual developers to construct their vertical search engines easily. FIG. 1 illustrates an existing implementation of a vertical search engine 110 based on the BOSS platform 120. There is a predefined curated list of network resources 112 associated with vertical search engine 110. Upon receiving a search query 132, vertical search engine 110 forwards search query 132 and predefined curated list of network resources 112 to BOSS platform 120 and instructs BOSS platform 120 to only search through predefined curated list of network resources 112 to identify network resources related to search query 132. Upon completing the search, BOSS platform 120 sends a set of data 136 that represents the result of the search to vertical search engine 110. Vertical search engine 110 in turn generates a search result 134 for search query 132 based on data 136 to be presented to the network user who has issued search query 132 to vertical search engine 110. The communications between vertical search engine 110 and BOSS platform 120 may be via the APIs provided by BOSS platform 120.

Currently, each vertical search engine usually requires its own associated curated list of network resources, which needs to be defined before the vertical search engine may function appropriately. In general, the quality of the search results generated by a vertical search engine depends at least in part on the quality of the associated curated list of network resources from which the search results are identified. Thus, much effort has been spent on constructing high-quality curated list of network resources for the individual vertical search engines.

To further improve on the qualities of the vertical search engine, particular embodiments may dynamically construct a list of network resources for a search query received at a search engine based on a set of user-provided network resources. The dynamic list of network resources may be used to identify the search result for the search query. Particular embodiments may enable a network user to store (e.g., cache) the dynamic lists constructed for the search queries specified by the network user to be used for future searches. By constructing dynamic lists of network resources for individual search queries, any broad-based search engine may in effect function as a specialized search engine focusing on specific subject matters or topics (i.e., verticals).

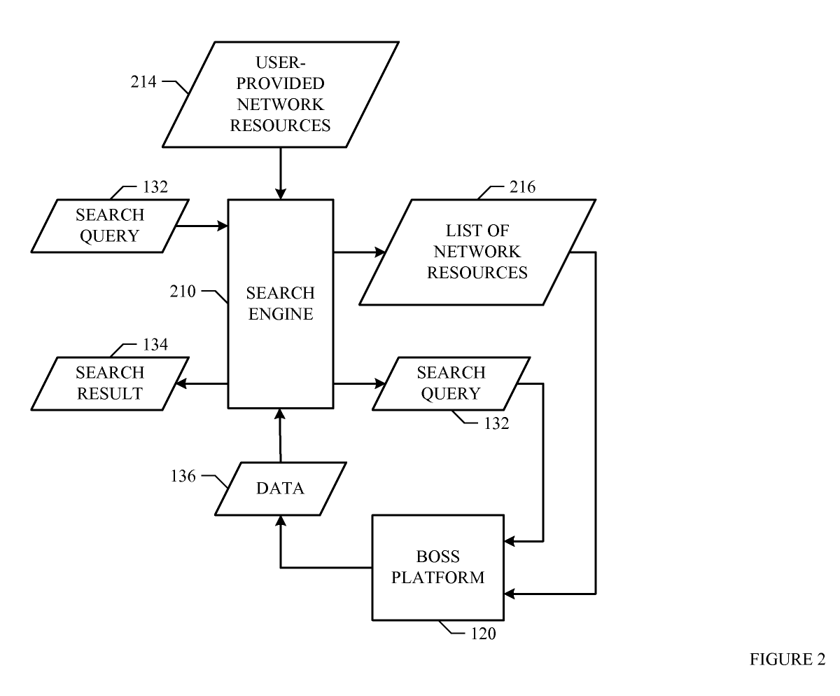

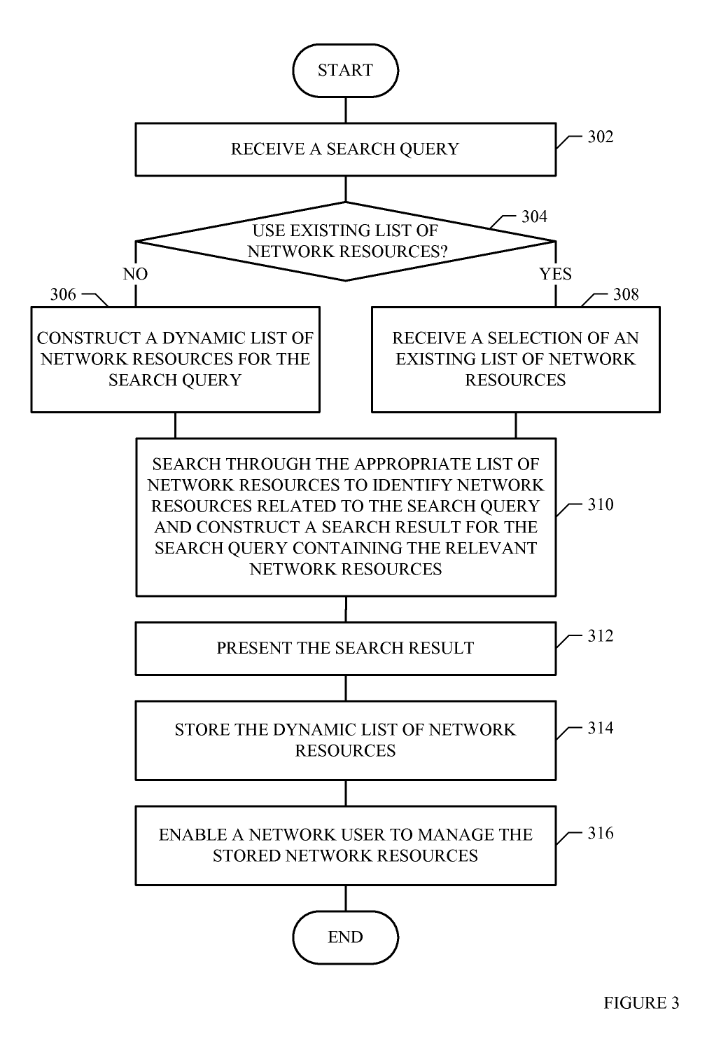

FIG. 2 illustrates an example search engine that incorporates dynamic lists of network resources constructed for individual search queries. FIG. 3 illustrates an example method for incorporating dynamic lists of network resources constructed for individual search queries to a search process. The steps illustrated in FIG. 3 are described with reference to the components illustrated in FIG. 2.

In particular embodiments, a network user may issue a search query (e.g., search query 132) to a search engine (e.g., search engine 210), as illustrated in step 302. Search engine 210 may be a broad-based search engine (e.g., the search engine provided by Yahoo!® Inc.) or a specialized search engine (e.g., a vertical search engine). For purpose of clarification, the network user issuing search query 132 to search engine 210 is hereafter referred to as “the current network user”. For example, suppose the current network user is searching for recipes for apple pie and has constructed search query 132 as “apple pie recipes”.

Particular embodiments allow the current network user to choose between having a new list of network resources dynamically constructed for search query 132 or using an existing list of network resources previously constructed for another search query (e.g., a previous search query describing a subject matter similar to that of search query 132) and saved for the current network user, as illustrated in step 304. Particular embodiments may present the options to the current network user via a browser-based user interface (UI) and allow the current network user to select the desired option.

If the current network user chooses to have a new list of network resources constructed for the current search query (i.e., search query 132 as “apple pie recipes”; step 304 “YES”), particular embodiments may dynamically construct a list of network resources (e.g., dynamic list of network resources 216) for search query 132, as illustrated in step 306. On the other hand, if the current network user chooses to use an existing list of network resources (step 304 “NO”), particular embodiments may enable the current network user to select a saved list of network resources to be used with search query 132.

Suppose the current network user chooses to have a new list of network resources constructed for search query 132 (step 304, “YES”). Particular embodiments may dynamically construct list of network resources 216 based on a set of user-provided network resources (e.g., user-provided network resources 214). In particular embodiments, user-provided network resources 214 may result from social collaboration among network users. For example, different network users may have visited various websites and viewed many web pages. Some of these network users may have found web pages that contain recipes for apple pie. If a network user considers that a web page contains a good recipe for apple pie, the network user may bookmark the web page for himself and may wish to share the information with other network users who may also wish to find good apple pie recipes. The network users may share network resources they consider to contain good information on specific subject matters at a centralized location (e.g., stored in a database). The network users may further provide and associate additional information with the network resources they share. The additional user-provided information associated with the network resources may be referred to as “meta-data” of the network resources. In addition to user-provided meta-data, a network resource may be associated with meta-data extracted from the content of the network resource, such as, without limitation, the title or the keywords of the network resource. List of network resources 216 may be constructed based on any suitable user-provided network resources.

For example, Delicious owned by Yahoo!® Inc. (http://delicious.com; formerly “del.icio.us”) is such a centralized location. Delicious is a social bookmarking web service that enables network users to store, share, and discover their web bookmarks. A Delicious user may tag each of his bookmarks with free-form index terms (i.e., the meta-data_. Suppose another network user (hereafter referred to as “the previous network user” for purpose of clarification) has previously visited a web page that the previous network user considers to contain several good apple pie recipes (e.g., http://allrecipes.com/Recipes/Desserts/Apple-Pies). The previous network user may have stored this web page's Uniform Resource Locator (URL) at Delicious and tagged the web page with an index term “apple pie recipes”. In this case, the tag “apple pie recipes” is a meta-datum associated with the web page that describes the content of the web page. When constructing dynamic list of network resources 216 for the current network user, particular embodiments may search through Delicious database and find the web page that is considered by the previous network user to contain good apple pie recipes based on the tags or other information associated with the web page by the previous network user. Particular embodiments may select website “allrecipes.com” to be included in the list based on the bookmark and tag provided by the previous network user.

Particular embodiments may exam user-provided network resources 214 and find network resources among them that the other network users have considered to contain good information relating to search query 132 (i.e., apple pie recipe) and include these particular network resources in list of network resources 216. If a network resource found in user-provided network resources 214 represents a web page, particular embodiments include the domain or the sub-domain to which the web page belongs in list of network resources 216. In the above example, the network resource stored in Delicious that contains good apple recipes is a web page at “allrecipes.com”. Thus, particular embodiments includes the domain name “allrecipes.com” in list of network resources 216 instead of the single web page itself. By using the domains or sub-domains instead of the individual web pages in list of network resources 216, particular embodiments take into consideration all web pages belonging to the selected domains or sub-domains when generating a search result (e.g., search result 134) for search query 132).

To find network resources among user-provided network resources 214 to be included in list of network resources 216 for search query 132, particular embodiments may compare the words of search query 132 or the concepts represented by the words of search query 132 with the meta-data (e.g., tags, descriptions, titles, keywords, etc.) associated the individual user-provided network resources 214. If there is sufficient similarly between search query 132 and the meta-data associated with a user-provided network resource, particular embodiments may include the domain or sub-domain to which that network resource belongs in list of network resources 216 dynamically constructed for search query 132.

Sometimes, multiple user-provided network resources 214 may relate to the same or similar subject matter, and some of these user-provided network resources may belong to the same domain or sub-domain (e.g., multiple web pages from “epicurious.com” may have been identified by different network users as containing information on apple pie recipes as the website “www.epicurious.com” focuses on food-related information). When constructing list of network resources 216 for a search query such as “apple pie recipe”, particular embodiments may indicate that the domain “epicurious.com” appears to be a more relevant domain (e.g., by placing the domain “epicurious.com” near the top of list of network resources 216). In fact, particular embodiments may rank list of network resources 216 based on their relative degrees of relevance to the search query for which list of network resources 216 is constructed based on, for example, how popular the domains or sub-domains are among user-provided network resources 214. Subsequently, when searching through list of network resources 216 (as described below in connection with step 310), the searching algorithm may take into consideration that those domains or sub-domains near the top of list of network resources 216 may be more relevant to the corresponding search query than those domains or sub-domains near the bottom of list of network resources 216 (e.g., “epicurious.com” may be especially relevant to search query “apple pie recipe”).

On the other hand, suppose the current network user chooses to use an existing list of network resources constructed for search query 132 (step 304, “NO”). The current network user may select an existing list of network resources via the browser-based UI. The user-selected list of network resources becomes list of network resources 216.

Particular embodiments may search through list of network resources 216 only to identify network resources related to search query 132 and construct search result 134 for search query 132 that includes the identified network resources, as illustrated in step 310. In particular embodiments, search engine 210 may forward search query 132 and list of network resources 216 to BOSS platform 120 and instructs BOSS platform 120 to only search through list of network resources 216 to identify network resources related to search query 132. Upon completing the search, BOSS platform 120 may send a set of data 136 that represents the result of the search to search engine 210. Search engine 210 may then generate search result 134 for search query 132 based on data 136. The communications between search engine 210 and BOSS platform 120 may be via the APIs provided by BOSS platform 120. Particular embodiments may present search result 134 to the current network user, as illustrated in step 312.

If list of network resources 216 has be dynamically constructed for search query 132 as described in connection with step 306, particular embodiments may present list of network resources 216 to the current network user so that the current network user may store list of network resources 216 for future use, as illustrated in step 314. For example, at some time in the future, the current network user may wish to find more apple pie recipes or may wish to find strawberry pie recipes. Instead of constructing new lists of network resources each time the current network user searches for pie recipes, the current network user may choose to use the same list of network resources in connection with additional searches for pie recipes as described in connection with step 308.

A network user may store one or more lists of network resources constructed for various search queries the network user issues to a search engine. Furthermore, particular embodiments may enable a network user to edit the stored lists of network resources via a browser-based UI, such as adding a network resource to a list or removing a network resource from a list, as illustrated in step 316. The network user may attach one or more tags to each stored list of network resources describing the subject matters to which the stored list of network resources relates. The network user may also rate each list of network resources (e.g., indicating the quality of the list of network resources with respect to a subject matter or to one or more keywords or search queries).

Once a network user has created one or more custom lists of network resources, particular embodiments may track the network user's behavior (e.g., by monitoring and tracking the network user's online activities) and add other network resources that the network user subsequently visits (e.g., when the network user clicks on a web page during a subsequent search) to the existing lists of network resources. For example, suppose the network user has searched for information on apple pie recipes and has created a list of network resources relating to apple pie recipes. Some time later, the same network user requests another search for information on cherry pie recipes and clicks on a web page included in the search result generated by a search engine. Particular embodiments may add the website to which the web page relating to cherry pie recipes belongs to the network user's list of network resources relating to apple pie recipes. Particular embodiments may first ask the network user's permission (e.g., using a pop-up window that prompts a response from the network user) before adding any network resource to one of the network user's lists of network resources.

Instead of using curated lists of network resources, as existing vertical search engines require, particular embodiments dynamically generate lists of network resources for individual search queries. Furthermore, the lists of network resources dynamically generated are based on user-provided network resources that have previously been reviewed by other network users and considered to contain good information on particular subject matters. Thus, the user-provided network resources provide a high-quality set of network resource on which the dynamically generated lists of network resources are based. Consequently, the dynamically generated lists of network resources contain high-quality network resources (i.e., network resources that are considered by network users to include good information on particular subject matters). As a result, the search results generated based on the dynamically generated lists of network resources also are of good qualities.

The user-provided network resources implicitly incorporate user inputs on the various network resourced contained therein. For example, a network user generally only recommends network resources that he considers to be of high quality. Thus, it is more likely that most or all of the user-provided network resources are of above-average or better quality, and bad-quality network resources are automatically excluded from the list of user-provided network resources. Each user-provided network resource may have user-provided information (e.g., in the form of tags) associated with it, and the user-provided information may provide additional indication as to which subject matter a particular user-provided network is closely related. In particular embodiments, the user-provided information associated with the user-provided network resources further enable a search engine (e.g., search engine 210) to select only those user-provided network resources that are closely related to a particular subject matter represented by a search query to be included in the list of network resource dynamically constructed for the search query as described in connection with step 306.

The dynamically constructed lists of network resources in effect enable any broad-based search engine to function as a specialized search engine (e.g., vertical search engine for a particular subject matter). As a result, it is no longer necessary to construct many vertical search engines, each focusing on a different subject matter. Instead, particular embodiments enable a broad-based search engine to function as different vertical search engines at different times for different search queries. It is also no longer necessary to create separate curated lists of network resources.

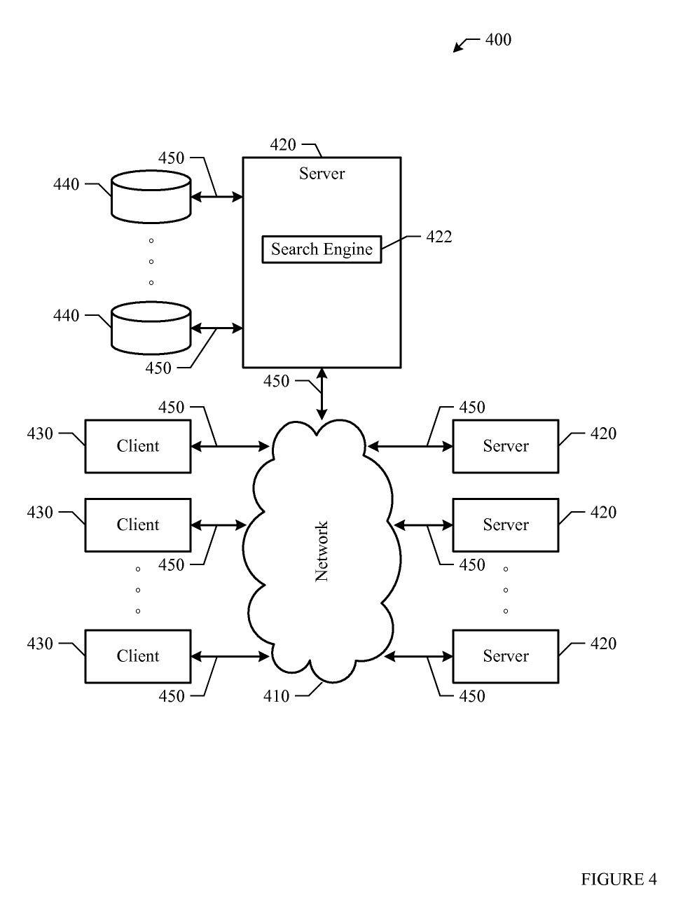

Particular embodiments may be implemented in a network environment. FIG. 4 illustrates an example network environment 400. Network environment 400 includes a network 410 coupling one or more servers 420 and one or more clients 430 to each other. In particular embodiments, network 410 is an intranet, an extranet, a virtual private network (VPN), a local area network (LAN), a wireless LAN (WLAN), a wide area network (WAN), a metropolitan area network (MAN), a communications network, a satellite network, a portion of the Internet, or another network 410 or a combination of two or more such networks 410. The present disclosure contemplates any suitable network 410.

One or more links 450 couple servers 420 or clients 430 to network 410. In particular embodiments, one or more links 450 each includes one or more wired, wireless, or optical links 450. In particular embodiments, one or more links 450 each includes an intranet, an extranet, a VPN, a LAN, a WLAN, a WAN, a MAN, a communications network, a satellite network, a portion of the Internet, or another link 450 or a combination of two or more such links 450. The present disclosure contemplates any suitable links 450 coupling servers 420 and clients 430 to network 410.

In particular embodiments, each server 420 may be a unitary server or may be a distributed server spanning multiple computers or multiple datacenters. Servers 420 may be of various types, such as, for example and without limitation, web server, news server, mail server, message server, advertising server, file server, application server, exchange server, database server, or proxy server. In particular embodiments, each server 420 may include hardware, software, or embedded logic components or a combination of two or more such components for carrying out the appropriate functionalities implemented or supported by server 420. For example, a web server is generally capable of hosting websites containing web pages or particular elements of web pages. More specifically, a web server may host HTML files or other file types, or may dynamically create or constitute files upon a request, and communicate them to clients 430 in response to HTTP or other requests from clients 430. A mail server is generally capable of providing electronic mail services to various clients 430. A database server is generally capable of providing an interface for managing data stored in one or more data stores.

In particular embodiments, each client 430 may be an electronic device including hardware, software, or embedded logic components or a combination of two or more such components and capable of carrying out the appropriate functionalities implemented or supported by client 430. For example and without limitation, a client 430 may be a desktop computer system, a notebook computer system, a netbook computer system, a handheld electronic device, or a mobile telephone. A client 430 may enable an network user at client 430 to access network 410. A client 430 may have a web browser, such as Microsoft Internet Explorer or Mozilla Firefox, and may have one or more add-ons, plug-ins, or other extensions, such as Google Toolbar or Yahoo Toolbar. A client 430 may enable its user to communicate with other users at other clients 430. The present disclosure contemplates any suitable clients 430.

In particular embodiments, one or more data storages 440 may be communicatively linked to one or more severs 420 via one or more links 450. In particular embodiments, data storages 440 may be used to store various types of information. In particular embodiments, the information stored in data storages 440 may be organized according to specific data structures. Particular embodiments may provide interfaces that enable servers 420 or clients 430 to manage (e.g., retrieve, modify, add, or delete) the information stored in data storage 440. Particular embodiments may store user-provided network resources together with their associated information (e.g., user-provided tags or descriptions) in one or more data storages 440. Particular embodiments may store dynamically constructed lists of network resources for individual search queries in one or more data storages 440.

In particular embodiments, a server 420 may include a search engine 422. Search engine 422 may include hardware, software, or embedded logic components or a combination of two or more such components for carrying out the appropriate functionalities implemented or supported by search engine 422. For example and without limitation, search engine 422 may implement one or more search algorithms that may be used to identify network resources in response to the search queries received at search engine 422, one or more ranking algorithms that may be used to rank the identified network resources, one or more summarization algorithms that may be used to summarize the identified network resources, and so on. Search engine 422 may perform some of the functionalities described in connection with FIG. 3, such as dynamically constructing lists of network resources for search queries received at search engine 422 based on user-provided network resources and instructing a BOSS platform to identify network resources among the lists of network resources to generate search results for the search queries.

Particular embodiments may be implemented as hardware, software, or a combination of hardware and software. For example and without limitation, one or more computer systems may execute particular logic or software to perform one or more steps of one or more processes described or illustrated herein. One or more of the computer systems may be unitary or distributed, spanning multiple computer systems or multiple datacenters, where appropriate. The present disclosure contemplates any suitable computer system. In particular embodiments, performing one or more steps of one or more processes described or illustrated herein need not necessarily be limited to one or more particular geographic locations and need not necessarily have temporal limitations. As an example and not by way of limitation, one or more computer systems may carry out their functions in “real time,” “offline,” in “batch mode,” otherwise, or in a suitable combination of the foregoing, where appropriate. One or more of the computer systems may carry out one or more portions of their functions at different times, at different locations, using different processing, where appropriate. Herein, reference to logic may encompass software, and vice versa, where appropriate. Reference to software may encompass one or more computer programs, and vice versa, where appropriate. Reference to software may encompass data, instructions, or both, and vice versa, where appropriate. Similarly, reference to data may encompass instructions, and vice versa, where appropriate.

One or more computer-readable storage media may store or otherwise embody software implementing particular embodiments. A computer-readable medium may be any medium capable of carrying, communicating, containing, holding, maintaining, propagating, retaining, storing, transmitting, transporting, or otherwise embodying software, where appropriate. A computer-readable medium may be a biological, chemical, electronic, electromagnetic, infrared, magnetic, optical, quantum, or other suitable medium or a combination of two or more such media, where appropriate. A computer-readable medium may include one or more nanometer-scale components or otherwise embody nanometer-scale design or fabrication. Example computer-readable storage media include, but are not limited to, compact discs (CDs), field-programmable gate arrays (FPGAs), floppy disks, floptical disks, hard disks, holographic storage devices, integrated circuits (ICs) (such as application-specific integrated circuits (ASICs)), magnetic tape, caches, programmable logic devices (PLDs), random-access memory (RAM) devices, read-only memory (ROM) devices, semiconductor memory devices, and other suitable computer-readable storage media.

Software implementing particular embodiments may be written in any suitable programming language (which may be procedural or object oriented) or combination of programming languages, where appropriate. Any suitable type of computer system (such as a single- or multiple-processor computer system) or systems may execute software implementing particular embodiments, where appropriate. A general-purpose computer system may execute software implementing particular embodiments, where appropriate.

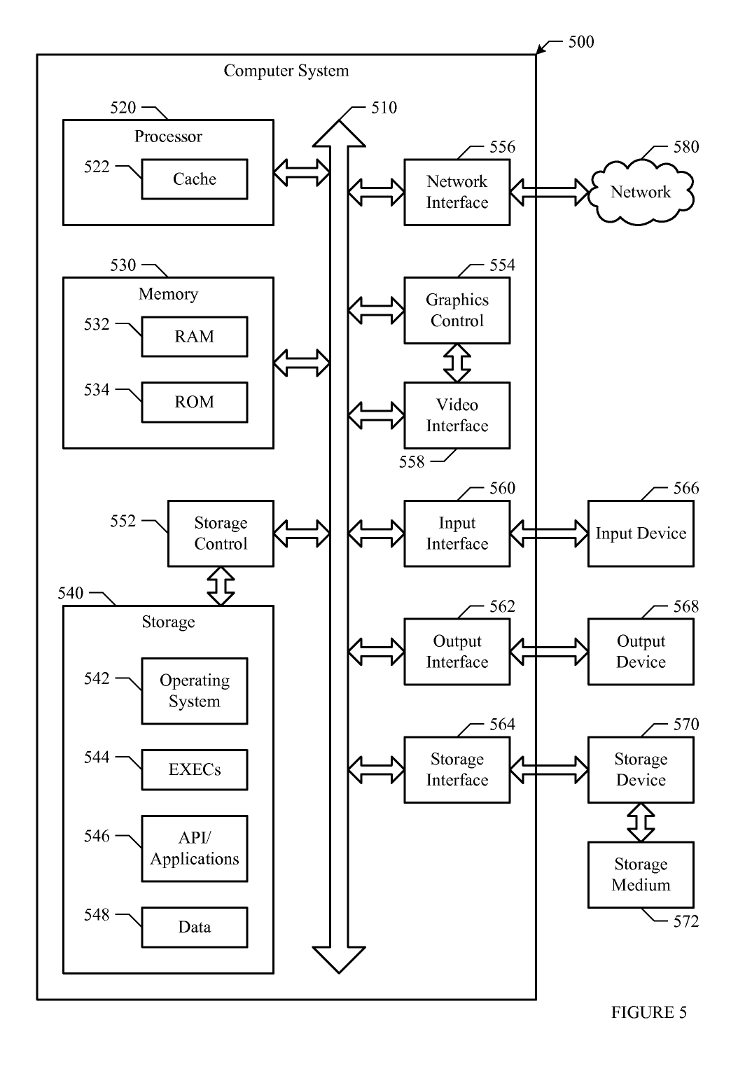

For example, FIG. 5 illustrates an example computer system 500 suitable for implementing one or more portions of particular embodiments. Although the present disclosure describes and illustrates a particular computer system 500 having particular components in a particular configuration, the present disclosure contemplates any suitable computer system having any suitable components in any suitable configuration. Moreover, computer system 500 may have take any suitable physical form, such as for example one or more integrated circuit (ICs), one or more printed circuit boards (PCBs), one or more handheld or other devices (such as mobile telephones or PDAs), one or more personal computers, or one or more super computers.

System bus 510 couples subsystems of computer system 500 to each other. Herein, reference to a bus encompasses one or more digital signal lines serving a common function. The present disclosure contemplates any suitable system bus 510 including any suitable bus structures (such as one or more memory buses, one or more peripheral buses, one or more a local buses, or a combination of the foregoing) having any suitable bus architectures. Example bus architectures include, but are not limited to, Industry Standard Architecture (ISA) bus, Enhanced ISA (EISA) bus, Micro Channel Architecture (MCA) bus, Video Electronics Standards Association local (VLB) bus, Peripheral Component Interconnect (PCI) bus, PCI-Express bus (PCI-X), and Accelerated Graphics Port (AGP) bus.

Computer system 500 includes one or more processors 520 (or central processing units (CPUs)). A processor 520 may contain a cache 522 for temporary local storage of instructions, data, or computer addresses. Processors 520 are coupled to one or more storage devices, including memory 530. Memory 530 may include random access memory (RAM) 532 and read-only memory (ROM) 534. Data and instructions may transfer bidirectionally between processors 520 and RAM 532. Data and instructions may transfer unidirectionally to processors 520 from ROM 534. RAM 532 and ROM 534 may include any suitable computer-readable storage media.

Computer system 500 includes fixed storage 540 coupled bidirectionally to processors 520. Fixed storage 540 may be coupled to processors 520 via storage control unit 552. Fixed storage 540 may provide additional data storage capacity and may include any suitable computer-readable storage media. Fixed storage 540 may store an operating system (OS) 542, one or more executables 544, one or more applications or programs 546, data 548, and the like. Fixed storage 540 is typically a secondary storage medium (such as a hard disk) that is slower than primary storage. In appropriate cases, the information stored by fixed storage 540 may be incorporated as virtual memory into memory 530.

Processors 520 may be coupled to a variety of interfaces, such as, for example, graphics control 554, video interface 558, input interface 560, output interface 562, and storage interface 564, which in turn may be respectively coupled to appropriate devices. Example input or output devices include, but are not limited to, video displays, track balls, mice, keyboards, microphones, touch-sensitive displays, transducer card readers, magnetic or paper tape readers, tablets, styli, voice or handwriting recognizers, biometrics readers, or computer systems. Network interface 556 may couple processors 520 to another computer system or to network 580. With network interface 556, processors 520 may receive or send information from or to network 580 in the course of performing steps of particular embodiments. Particular embodiments may execute solely on processors 520. Particular embodiments may execute on processors 520 and on one or more remote processors operating together.

In a network environment, where computer system 500 is connected to network 580, computer system 500 may communicate with other devices connected to network 580. Computer system 500 may communicate with network 580 via network interface 556. For example, computer system 500 may receive information (such as a request or a response from another device) from network 580 in the form of one or more incoming packets at network interface 556 and memory 530 may store the incoming packets for subsequent processing. Computer system 500 may send information (such as a request or a response to another device) to network 580 in the form of one or more outgoing packets from network interface 556, which memory 530 may store prior to being sent. Processors 520 may access an incoming or outgoing packet in memory 530 to process it, according to particular needs.

Computer system 500 may have one or more input devices 566 (which may include a keypad, keyboard, mouse, stylus, etc.), one or more output devices 568 (which may include one or more displays, one or more speakers, one or more printers, etc.), one or more storage devices 570, and one or more storage medium 572. An input device 566 may be external or internal to computer system 500. An output device 568 may be external or internal to computer system 500. A storage device 570 may be external or internal to computer system 500. A storage medium 572 may be external or internal to computer system 500.

Particular embodiments involve one or more computer-storage products that include one or more computer-readable storage media that embody software for performing one or more steps of one or more processes described or illustrated herein. In particular embodiments, one or more portions of the media, the software, or both may be designed and manufactured specifically to perform one or more steps of one or more processes described or illustrated herein. In addition or as an alternative, in particular embodiments, one or more portions of the media, the software, or both may be generally available without design or manufacture specific to processes described or illustrated herein. Example computer-readable storage media include, but are not limited to, CDs (such as CD-ROMs), FPGAs, floppy disks, floptical disks, hard disks, holographic storage devices, ICs (such as ASICs), magnetic tape, caches, PLDs, RAM devices, ROM devices, semiconductor memory devices, and other suitable computer-readable storage media. In particular embodiments, software may be machine code which a compiler may generate or one or more files containing higher-level code which a computer may execute using an interpreter.

As an example and not by way of limitation, memory 530 may include one or more computer-readable storage media embodying software and computer system 500 may provide particular functionality described or illustrated herein as a result of processors 520 executing the software. Memory 530 may store and processors 520 may execute the software. Memory 530 may read the software from the computer-readable storage media in mass storage device 530 embodying the software or from one or more other sources via network interface 556. When executing the software, processors 520 may perform one or more steps of one or more processes described or illustrated herein, which may include defining one or more data structures for storage in memory 530 and modifying one or more of the data structures as directed by one or more portions the software, according to particular needs. In addition or as an alternative, computer system 500 may provide particular functionality described or illustrated herein as a result of logic hardwired or otherwise embodied in a circuit, which may operate in place of or together with software to perform one or more steps of one or more processes described or illustrated herein. The present disclosure encompasses any suitable combination of hardware and software, according to particular needs.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A method, comprising:
accessing, by one or more computer systems, a first search query received by a search engine;
dynamically constructing, by the one or more computer systems, a list of network resources for the first search query, the list of network resources comprising one or more network resources that are relevant to the first search query, the list of network resources being determined based on analysis of a plurality of user-provided network resources;
conducting, by the one or more computer systems, a first search through the list of network resources using the first search query; and
generating, by the one or more computer systems, a first search result for the first search query based on a result of the first search.

2. The method recited in claim 1, wherein each of the plurality of user-provided network resources is identified by a user and is associated with one or more meta-data provided by the user that describe the user-provided network resource.

3. The method recited in claim 2, wherein:
each of the list of network resources is a domain or a sub-domain; and
dynamically constructing the list of network resources comprises:
comparing the first search query with each of the plurality of user-provided network resources and its associated meta-data; and
for each of the plurality of user-provided network resources having associated meta-data relating to the first search query, including the domain or the sub-domain to which the user-provided network resource belongs in the list of network resources.

4. The method recited in claim 1, further comprising storing, by the one or more computer systems, the list of network resources.

5. The method recited in claim 4, further comprising providing, the one or more computer systems, an interface that enables a user to edit the list of network resources.

6. The method recited in claim 4, further comprising:
accessing, by the one or more computer systems, a second search query received by the search engine;
conducting, by the one or more computer systems, a second search through the list of network resources using the second search query; and
generating, by the one or more computer systems, a second search result for the second search query based on a result of the second search.

7. A system, comprising:
a memory comprising instructions executable by one or more processors; and
one or more processors coupled to the memory and operable to execute the instructions, the one or more processors being operable when executing the instructions to:
access a first search query received by a search engine;
dynamically construct a list of network resources for the first search query, the list of network resources comprising one or more network resources that are relevant to the first search query, the list of network resources being determined based on analysis of a plurality of user-provided network resources;
conduct a first search through the list of network resources using the first search query; and
generate a first search result for the first search query based on a result of the first search.

8. The system recited in claim 7, wherein each of the plurality of user-provided network resources is identified by a user and is associated with one or more meta-data provided by the user that describe the user-provided network resource.

9. The system recited in claim 8, wherein:
each of the list of network resources is a domain or a sub-domain; and
to dynamically construct the list of network resources comprises:
compare the first search query with each of the plurality of user-provided network resources and its associated meta-data; and
for each of the plurality of user-provided network resources having associated meta-data relating to the first search query, include the domain or the sub-domain to which the user-provided network resource belongs in the list of network resources.

10. The system recited in claim 7, wherein the one or more processors being further operable when executing the instructions to store the list of network resources.

11. The system recited in claim 10, wherein the one or more processors being further operable when executing the instructions to provide an interface that enables a user to edit the list of network resources.

12. The system recited in claim 10, wherein the one or more processors being further operable when executing the instructions to:
access a second search query received by the search engine;
conduct a second search through the list of network resources using the second search query; and
generate a second search result for the second search query based on a result of the second search.

13. One or more computer-readable storage media embodying software operable when executed by one or more computer systems to:
access a first search query received by a search engine;
dynamically construct a list of network resources for the first search query, the list of network resources comprising one or more network resources that are relevant to the first search query, the list of network resources being determined based on analysis of a plurality of user-provided network resources;
conduct a first search through the list of network resources using the first search query; and
generate a first search result for the first search query based on a result of the first search.

14. The media recited in claim 13, wherein each of the plurality of user-provided network resources is identified by a user and is associated with one or more meta-data provided by the user that describe the user-provided network resource.

15. The media recited in claim 14, wherein:
each of the list of network resources is a domain or a sub-domain; and
to dynamically construct the list of network resources comprises:
compare the first search query with each of the plurality of user-provided network resources and its associated meta-data; and
for each of the plurality of user-provided network resources having associated meta-data relating to the first search query, include the domain or the sub-domain to which the user-provided network resource belongs in the list of network resources.

16. The media recited in claim 13, wherein the software is further operable when executed by one or more computer systems to store the list of network resources.

17. The media recited in claim 16, wherein the software is further operable when executed by one or more computer systems to provide an interface that enables a user to edit the list of network resources.

18. The media recited in claim 16, wherein the software is further operable when executed by one or more computer systems to:
access a second search query received by the search engine;
conduct a second search through the list of network resources using the second search query; and
generate a second search result for the second search query based on a result of the second search.
